(19) United States
(12) Patent Application Publication
(10) Pub. No.: US 2025/0119911 A1
(43) Pub. Date: Apr. 10, 2025

(54) Scheduling Usage Across Multiple Downlink Slots

(71) Applicant: Parallel Wireless, Inc., Nashua, NH (US)

(72) Inventors: Vipin Mishra, Pune (IN); Sandeep Mittal, Pune (IN); Darpan Dhodi, Pune (IN); Moti Peretz, Oranit (IL); Gaurav Goel, Pune (IN); Amichai Markovitz, Kfar Saba (IL)

(21) Appl. No.: 18/908,789

(22) Filed: Oct. 7, 2024

Related U.S. Application Data
(60) Provisional application No. 63/588,425, filed on Oct. 6, 2023.

(51) Int. Cl. H04W 72/1268; H04W 72/0446; H04W 72/231

(52) U.S. Cl. CPC H04W 72/1268; H04W 72/0446; H04W 72/231

(57) ABSTRACT

In a first embodiment, a method is disclosed for providing uplink scheduling in a cellular radio base station, comprising: an uplink (UL) scheduler running 6 TTI in advance to thereby provide a list of all Radio Network Temporary Identifiers (RNTIs) to be scheduled on a given UL slot; allocating, at a PDCCH resource allocator, control channel elements (CCEs) for all downlink (DL) RNTIs first; allocating, at the PDCCH resource allocator, CCEs for at least one UL RNTI for a first DL slot; placing RNTIs not allocated in the first DL slot in a pending queue.

### CROSS-REFERENCE TO RELATED APPLICATIONS

The present application claims priority under 35 U.S.C. § 119 (e) to U.S. Provisional Patent App. No. 63/588,425, having the same title as the present application and filed Oct. 6, 2023, hereby incorporated by reference for all purposes in its entirety.

This application also hereby incorporates by reference, for all purposes, each of the following U.S. Patent Application Publications in their entirety: US20230269633A1; US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; US20170257133A1; and US20200128414A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,,418, and 9,232,547 in their entirety. This document also hereby incorporates by reference U.S. patent application Ser. No. 14/822,839, U.S. patent application Ser. No. 15/828,427, U.S. Pat. App. Pub. Nos. U.S. Pat. No. 20,170,273134A1, US20170127409A1, US20200128414A1, US20230019380A1 in their entirety. Features and characteristics of and pertaining to the systems and methods described in the present disclosure, including details of the multi-RAT nodes and the gateway described herein, are provided in the documents incorporated by reference.

### BACKGROUND

PDCCH channel in 5G (defined by CORESET) is carrying downlink control information (DCI), providing scheduling details of different RNTI's (i.e., UEs) in DL and UL for a given slot. This is the most important channel, which is supposed to be very robust and should be easily decodable even in harsh radio conditions. As we need to schedule more and more UEs in DL and UL, we need to have a way to optimally use PDCCH, so that we don't reduce resources for PDSCH, where actual data is scheduled.

### SUMMARY

This is about Optimization in PDCCH usage by spreading scheduling across multiple DL slots for a given UL slot for TDD.

With evolution of technology, in urban/semi-urban areas, demands for high data rates, lower latency and higher number of supported users is continuously increasing. To meet these requirements, an operator need to deploy eNodeBs and gNodeBs which support a large number of connected/active UE's while meeting high data rates and lower latency. To support such high UE load, gNodeB scheduler will have to support scheduling of high numbers of UEs in DL and UL. This raises a need for optimal use of control channels so that more data can be scheduled.

A scheduler is disclosed that uses multiple time domain allocation values (e.g., K2) to thereby reduce the need for extra symbols in PDCCH.

In a first embodiment, a method is disclosed for providing uplink scheduling in a cellular radio base station, comprising: an uplink (UL) scheduler running 6 TTI in advance to thereby provide a list of all Radio Network Temporary Identifiers (RNTIs) to be scheduled on a given UL slot; allocating, at a PDCCH resource allocator, control channel elements (CCEs) for all downlink (DL) RNTIs first; allocating, at the PDCCH resource allocator, CCEs for at least one UL RNTI for a first DL slot; placing RNTIs not allocated in the first DL slot in a pending queue.

The method may further comprise, wherein for the first allocation, PDCCH tries to allocate CCEs using K2=6. The method may further comprise, wherein RNTIs not allocated in this DL slot may be placed in a pending queue The method may further comprise, wherein if UL RBs may be left, distributing, by the UL resource allocator, the remaining UL RBs to other scheduled RNTIs in the given slot. The method may further comprise, wherein in the next DL slot, the PDCCH allocator tries to allocate CCEs for UEs in the pending queue with K2=4. The method may further comprise, wherein in a subsequent DL slot, the PDCCH allocator tries to allocate CCEs for UEs in the pending queue with K2=3. The method may further comprise, wherein in a subsequent DL slot, the PDCCH allocator tries to allocate CCEs for UEs in the pending queue with K2=2.

In a second embodiment, a non-transitory computer-readable medium is disclosed containing instructions which, when executed on a processor at a cellular base station, performs steps, the steps comprising: an uplink (UL) scheduler running 6 TTI in advance to thereby provide a list of all Radio Network Temporary Identifiers (RNTIs) to be scheduled on a given UL slot; allocating, at a PDCCH resource allocator, control channel elements (CCEs) for all downlink (DL) RNTIs first; allocating, at the PDCCH resource allocator, CCEs for at least one UL RNTI for a first DL slot; placing RNTIs not allocated in the first DL slot in a pending queue.

The instructions may further comprise, for the first allocation, PDCCH tries to allocate CCEs using K2=6. The instructions may further comprise, RNTIs not allocated in this DL slot may be placed in a pending queue The instructions may further comprise, if UL RBs may be left, distributing, by the UL resource allocator, the remaining UL RBs to other scheduled RNTIs in the given slot. The instructions may further comprise, in the next DL slot, the PDCCH allocator tries to allocate CCEs for UEs in the pending queue with K2=4. The instructions may further comprise, in a subsequent DL slot, the PDCCH allocator tries to allocate CCEs for UEs in the pending queue with K2=3. The instructions may further comprise, in a subsequent DL slot, the PDCCH allocator tries to allocate CCEs for UEs in the pending queue with K2=2.

### BRIEF DESCRIPTION OF THE DRAWINGS

FIG. 1A is a schematic diagram of packing data symbols by a scheduler to enable micro-sleep, in some embodiments.

FIG. 1B is a schematic diagram of sending a PA power-on schedule to enable micro-sleep, in some embodiments.

FIG. 2 is a schematic diagram of 3GPP functional splits, as known in the prior art.

FIG. 3 is a schematic diagram of an Open RAN 4G/5G deployment architecture, as known in the prior art.

FIG. 4 is a first schematic diagram of a multi-RAT RAN deployment architecture, in accordance with some embodiments.

FIG. 5 is a second schematic diagram of a multi-RAT RAN deployment architecture, in accordance with some embodiments.

FIG. 6 is a third schematic diagram of a multi-RAT RAN deployment architecture, in accordance with some embodiments.

FIG. 7 is a fourth schematic diagram of a multi-RAT RAN deployment architecture, in accordance with some embodiments.

FIG. 8 is a fifth schematic diagram of a multi-RAT RAN deployment architecture, in accordance with some embodiments.

FIG. 9 is a schematic diagram of a multi-RAT RAN deployment in operation, in accordance with some embodiments.

### DETAILED DESCRIPTION

In TDD system, when gNodeB schedules uplink grant for UE, it needs to send DCI_0_x in DL over PDCCH with K2 value, to inform UE to send UL data after K2 slots. There are certain DL slots where gNodeB will transmit DCI_1_x for DL scheduling and will also have DCI_0_x for uplink scheduling, this will increase the resource requirement for PDCCH. In certain condition, this may force allocating additional symbol to PDCCH, causing less resources available for PDSCH, affecting spectral efficiency. This proposal tries maximizing the use of control channel without allocating additional symbol to PDCCH, so that we can have higher spectral efficiency.

In 4G and 5G, PDCCH channel carries control information, namely, DCI, Downlink Control Information and in 5G the following DCIs are available: 0_0, 0_1, 1_0, 1_1, 2_0, 2_1, 2_2, 2_2, 2_3, 2_4, 2_5, 2_6, 3_0, 3_1, further defined in 3GPP TS 38.212, hereby incorporated by reference. DCI: carries the information to schedule (allocate physical resources) for Downlink Data (PDSCH); carries the information to schedule (allocate physical resources) for Uplink Data (PUSCH); and carries the information to adjust Uplink Power (PUSCH, PUCCH power) for power control.

Resources (CCEs) for PDDCH are allocated from downlink spectrum of RBs and symbols. Hence higher resources allocated to PDCCH causes reduction in spectral efficiency as less symbols/RBs are available for PDSCH. This problem is inherited from LTE TDD, where extra PDCCH resources are required for the subframe when scheduling DCI for both DL and UL. In LTE we try to solve this problem by dynamically changing the CFI value and try to reduce the impact to subframe where DL+UL DCIs is getting scheduled.

It is noted that important parameters related to Resource Allocation in Time Domain and Ack/Nack responses are: k0, k1, k2, SLIV, N1, N2. k0 indicates the number of time slot between PDCCH/DCI and Downlink Data (PDSCH) transmission (e.g, if DCI and PDSCH is in the same slot, k0 becomes 0). k1 indicates the number of time slot between PDSCH and HARQ Ack/Nack transmission. k2 indicates the number of time slot between PDCCH/DCI and Uplink Data (PUSCH) transmission.

Let's take a case of 100 MHz, TDD config DDDSU. Suppose we want to schedule up to 16 UE in DL and 24 UE UL at an average aggregation level of 2. PDCCH resources needed for this would be:

CCE's need for DCI_1_x=16*2=32

CCE's need for DCI_0_x=24*2=48.

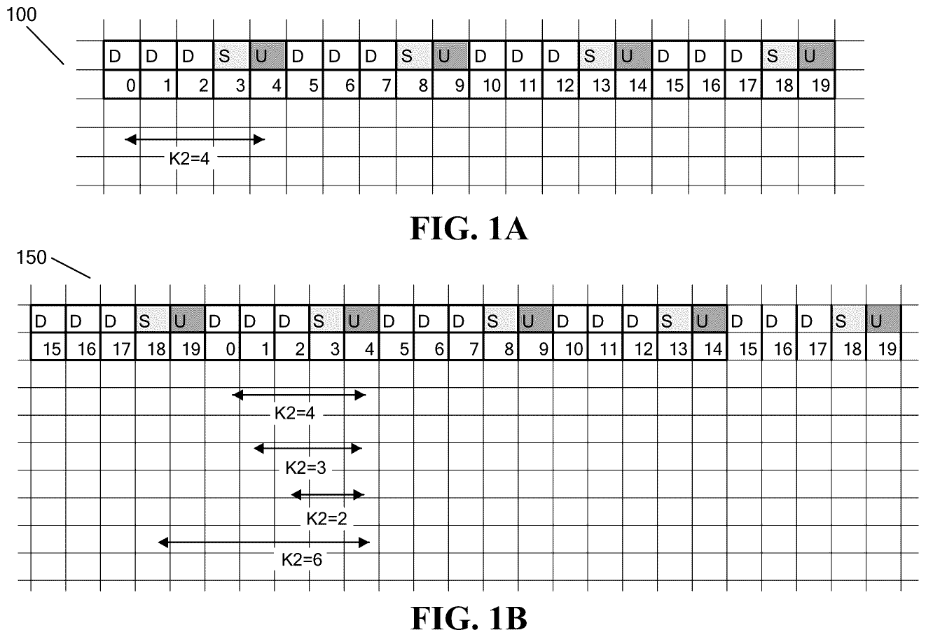

For 100 MHz, we have 45 CCE per symbol. If we want to schedule all the DCIs in 1 slot, since 45 CCEs are needed, we will need at least 2 symbols for PDCCH to schedule all these DCIs. Typically (as in LTE (i.e K2=4)) if we want to schedule UE on UL slot=4, we thus need to schedule DCI_0_x on slot 0. (as shown in FIG. 1A). So, on slot=0 we need 2 PDCCH symbols. So, we need to define the CORESET which has 2 PDCCH symbols. This will roughly cause 9% drop in DL throughput. (Assuming DDSCH is getting scheduled on 11 symbols).

There are many different solutions to address this problem.

In some embodiments we may define 2 CORESETs, CORESET-1 having 2 PDCCH symbols and CORESET-2 having 1 PDCCH symbols. On DL slots (like slot 0 in above case), we schedule RNTI's with CORESET-1, and on other DL slots schedule UE's on CORESET-2. This will reduce the drop up to 75%, where overall DL throughput drop would reduce to ^{˜}3%.

In some embodiments we may use multiple slots to schedule DCI_0_x for same UL frame. This can be done by configuring multiple values on K2, in some embodiments. By this we can schedule all RNTI's using 1 symbol of PDCCH and can schedule maximum data in DL.

It is desirable to have a solution having characteristics of both 1 and 2. We will call this approach 3. We will discuss approach 2 in more detail and can see how we can use approach 3 to cover most of the cases.

Taking the above example of TDD config. In some embodiments, by setting four different K2 values (2,3,4,6), this enables us to schedule the UL on multiple DL slots now, as shown in FIG. 1B.

To enable this, in some embodiments, the following steps or components are desirable: UL scheduler, running 6 TTI in advance (or another number of TTIs as appropriate), may provide a list of all RNTI's to be scheduled on UL slot; PDCCH resource allocator that will first allocate the CCE's for all DL RNTI's; then PDCCH will try to allocate CCE's for UL RNTI's. First time PDCCH will try to allocate CCE's using K2=6. Those RNTI's which are not allocated in this DL slot, will put in a pending queue. If UL RBs are left, UL resource allocator can distribute them to other scheduled UEs in given slot. In the next DL slot, PDCCH allocator will try to allocate CCE's for UEs in pending queue with K2=4. Similarly, CCE's will be allocated for K2=3 and K2=2.

This way whatever CCE's are left after allocation of CCE's for DL, can be allocated to UL. And by distributing UL CCEs allocation in multiple DL slots, we don't need to increase PDCCH symbols.

As per above example and diagram: 16 DL RNTI's can be allocated on SLOT 18. And additionally, 12 CCEs (for 6 UL RNTI's) can be allocated for UL slot 4, can be allocated on this SLOT (18).

Similarly, 16 DL RNTI's can be allocated on SLOT 0. And additionally, 12 CCEs (for 6 UL RNTI's) can be allocated for UL slot 4, can be allocated on this SLOT (0).

Similarly, 16 DL RNTI's can be allocated on SLOT 1. And additionally, 12 CCEs (for 6 UL RNTI's) can be allocated for UL slot 4, can be allocated on this SLOT (1).

Similarly, 16 DL RNTI's can be allocated on SLOT 2. And additionally, 12 CCEs (for 6 UL RNTI's) can be allocated for UL slot 4, can be allocated on this SLOT (3).

In total, 24 UL RNTI's can be allocated using 1 PDCCH symbol.

Thus, more optimized use of PDCCH using this method, using an enhanced scheduler.

This scheme works well even when we must allocate higher aggregation level for more UE's.

UL allocation can be done up to last available DL slot before UL slot, there by reducing the scheduling time for UE and overall reducing the RTT.

Retransmission or other priority scheduling can be done at last available DL slot.

Different numbers of K2 allocations can be used.

This scheme may work for 4G as well as 5G. This scheme may be used in conjunction with a multi-RAT base station or RRH. Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

### Radio Unit Functional Splits

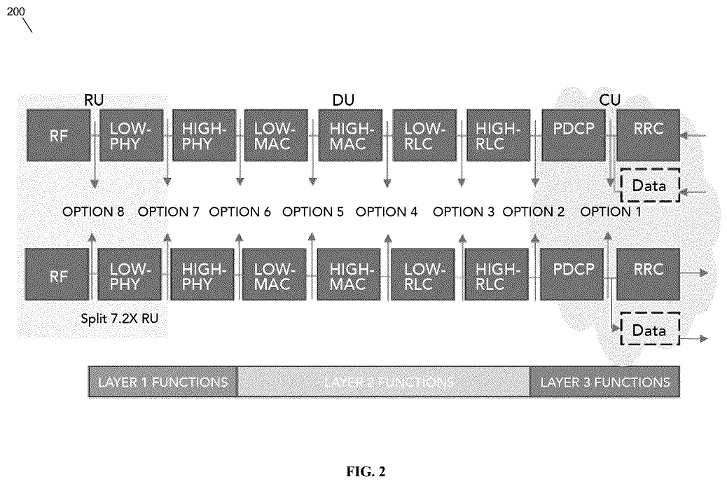

FIG. 2 shows a schematic diagram of radio functional splits showing split 7.2X RU as well as other splits. The use of these functional splits is encouraged by ORAN.

5G New Radio (NR) was designed to allow for disaggregating the baseband unit (BBU) by breaking off functions beyond the Radio Unit (RU) into Distributed Units (DUs) and Centralized Units (CUs), which is called a functional split architecture. This concept has been extended to 4G as well.

RU: This is the radio hardware unit that coverts radio signals sent to and from the antenna into a digital signal for transmission over packet networks. It handles the digital front end (DFE) and the lower PHY layer, as well as the digital beamforming functionality. 5G RU designs are supposed to be inherently intelligent, but the key considerations of RU design are size, weight, and power consumption. Deployed on site.

DU: The distributed unit software that is deployed on site on a COTS server. DU software is normally deployed close to the RU on site and it runs the RLC, MAC, and parts of the PHY layer. This logical node includes a subset of the eNodeB (eNB)/gNodeB (gNB) functions, depending on the functional split option, and its operation is controlled by the CU.

CU: The centralized unit software that runs the Radio Resource Control (RRC) and Packet Data Convergence Protocol (PDCP) layers. The gNB consists of a CU and one DU connected to the CU via Fs-C and Fs-U interfaces for CP and UP respectively. A CU with multiple DUs will support multiple gNBs. The split architecture lets a 5G network utilize different distributions of protocol stacks between CU and DUs depending on midhaul availability and network design. It is a logical node that includes the gNB functions like transfer of user data, mobility control, RAN sharing (MORAN), positioning, session management etc., except for functions that are allocated exclusively to the DU. The CU controls the operation of several DUs over the midhaul interface. CU software can be co-located with DU software on the same server on site.

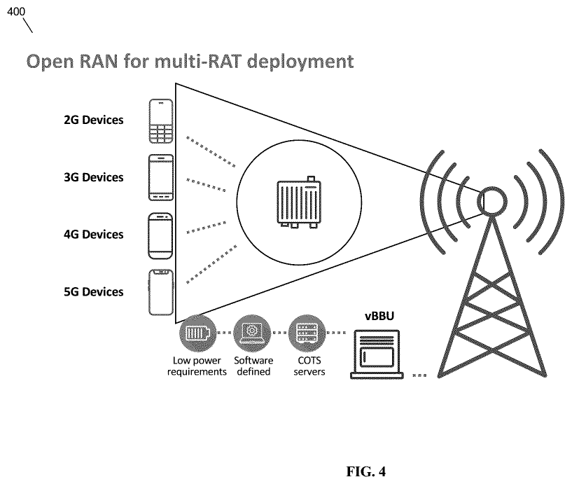

When the RAN functional split architecture (FIG. 4) is fully virtualized, CU and DU functions runs as virtual software functions on standard commercial off-the-shelf (COTS) hardware and be deployed in any RAN tiered datacenter, limited by bandwidth and latency constraints.

Option 7.2 (shown) is the functional split chosen by the O-RAN Alliance for 4G and 5G. It is a low-level split for ultra-reliable low-latency communication (URLLC) and near-edge deployment. RU and DU are connected by the eCPRI interface with a latency of ^{˜}100 microseconds. In O-RAN terminology, RU is denoted as O-RU and DU is denoted as O-DU. Further information is available in US20200128414A1, hereby incorporated by reference in its entirety.

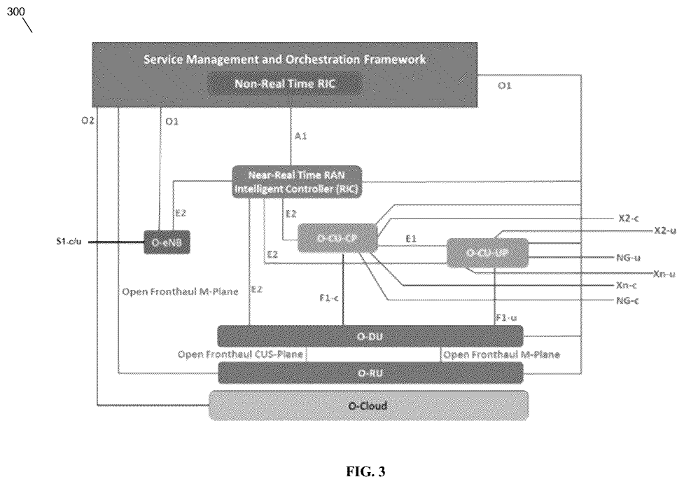

FIG. 3 is a schematic diagram of an Open RAN 4G/5G deployment architecture, as known in the prior art. The O-RAN deployment architecture includes an O-DU and O-RU, as described above with respect to FIG. 2, which together comprise a 5G base station in the diagram as shown. The O-CU-CP (central unit control plane) and O-CU-UP (central unit user plane) are ORAN-aware 5G core network nodes. An ORAN-aware LTE node, O-eNB, is also shown. As well, a near-real time RAN intelligent controller is shown, in communication with the CU-UP, CU-CP, and DU, performing near-real time coordination As well, a non-real time RAN intelligent controller is shown, receiving inputs from throughout the network and specifically from the near-RT RIC and performing service management and orchestration (SMO), in coordination with the operator's network (not shown). Absent from the ORAN network concept is any integration of 2G, 3G. Also absent is any integration of a 2G/3G/4G DU or RU.

FIG. 4 is a first schematic diagram of a multi-RAT RAN deployment architecture, in accordance with some embodiments. FIG. 4 shows a radio tower with a remote radio head (RRH) supporting multiple RATs, 2G/3G/4G/5G, but without requiring four generations of radio base stations as shown in FIG. 1. Instead, one or more software-upgradable, remotely configurable base stations is coupled to radio heads and filters that are able to operate on the appropriate frequencies for 2G, 3G, 4G, and 5G RATs. The multiple BBUs located at the bottom of the tower in FIG. 1 have been replaced with one or more vBBUs, baseband units that are rearchitected to use modern virtualization technologies. FIG. 4 can be enabled using a technology like CPRI or eCPRI, which enables digitization and transfer of radio I/Q samples for further processing at a BBU or vBBU.

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The inventors have appreciated that the use of the 3GPP model for functional splits is flexible and may be used to provide deployment flexibility for multiple RATs, not just 5G. Functional splits can be used in conjunction with cloud and virtualization technology to perform virtualization of, e.g., the RU, DU, and CU of not just 5G but also 4G, 3G, 2G, etc. This enables the use of commodity off-the-shelf servers, software-defined networking that can be rapidly upgraded remotely, and lower power requirements by using modern hardware compared to legacy hardware.

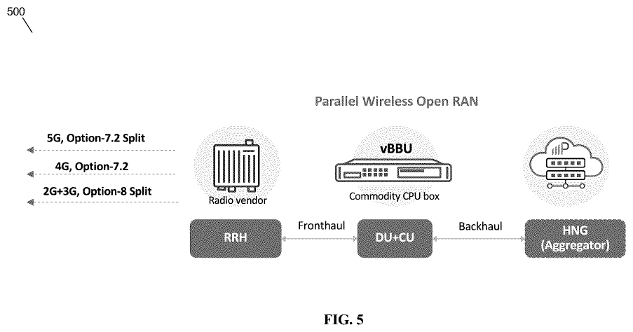

FIG. 5 is a second schematic diagram of a multi-RAT RAN deployment architecture, in accordance with some embodiments. As shown, a single RRH supports a 5G RAT with an Option 7.2 split, a 4G RAT with an Option 7.2 split, and 2G+3G with an Option 8 split. With the Option 7.2 split, the PHY is split into High PHY and Low PHY. For option 7-2, the uplink (UL), CP removal, fast Fourier transform (FFT), digital beamforming (if applicable), and prefiltering (for PRACH (Physical Random Access Channel) only) functions all occur in the RU. The rest of the PHY is processed in the DU. For the downlink (DL), the inverse FFT (iFFT), CP addition, precoding functions, and digital beamforming (if applicable) occur in the RU, and the rest of the PHY processing happens in the DU. This is the preferred ORAN split for 5G, and can also be used for 4G. For 2G+3G, an Option 8 split is preferred, where only RF will be performed at the RU and further processing (PHY/MAC/RLC/PDCP) is performed at the vBBU. This is desirable because the processing and latency requirements for 2G and 3G are lower, and are readily fulfilled by a BBU or VBBU.

Continuing with FIG. 5, a fronthaul link connects the RRH to a DU+CU, which runs a variety of virtualized RAT processing on a vBBU machine. The fronthaul link may be CPRI or eCPRI, or another similar interface. The DU+CU may be located at the base of the tower or at a further remove as enabled by different latency envelopes; typically this will be close to the tower for a 5G deployment. In some embodiments, a HetNet Gateway (HNG), which performs control and user plane data aggregation and gateway services, may be the next destination via the backhaul connection; the HNG may disaggregate the different RAT communications to be directed to different RAT cores (i.e., a 2G core, a 3G core, a 4G core, a 5G core and so on). In some embodiments and in certain situations, an HNG may perform virtualization or interworking of aggregated communications such that, e.g., 2G communications may be interworked to 4G IP voice communications and routed through the 4G core. In some embodiments, the HNG may perform virtualization of one or more cores such that the communications may not need to terminate at a RAT-specific core; this feature may be combined with interworking in some embodiments. In some embodiments, no aggregator may be present and the vBBU may directly route communications to each RAT's individual core.

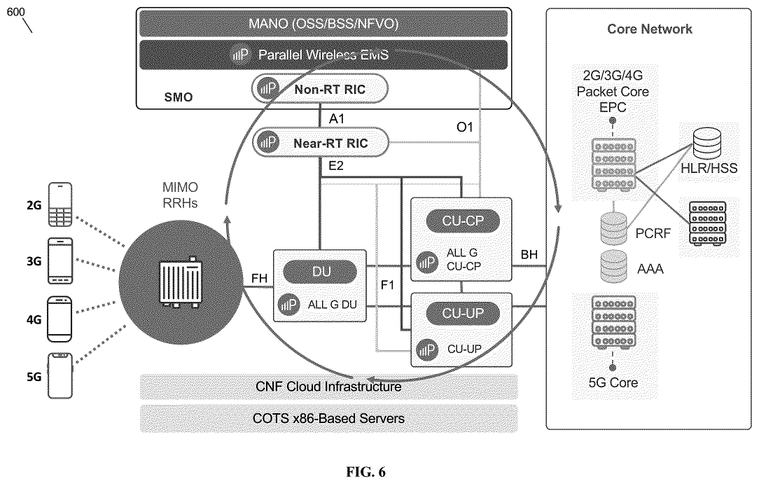

FIG. 6 is a third schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interwokring processes or which may involve supporting a subset of available commands for a RAT, in some embodiments.

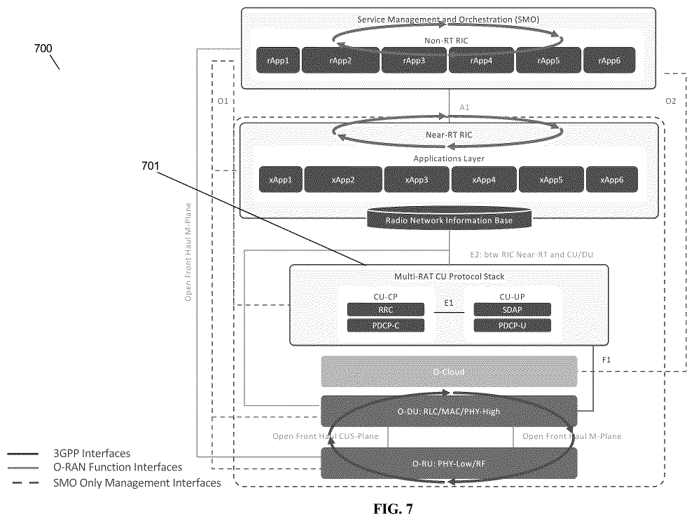

FIG. 7 is a fourth schematic diagram of a multi-RAT RAN deployment architecture, in accordance with some embodiments. The multi-RAT CU protocol stack 701 is configured as shown and enables a multi-RAT CU-CP and multi-RAT CU-UP, performing RRC, PDCP, and SDAP for all-G. As well, some portion of the base station (DU or CU) may be in the cloud or on COTS hardware (O-Cloud), as shown. Coordination with SMO and the all-G near-RT RIC and the all-G non-RT RIC may be performed using the A1 and O2 function interfaces, as shown and elsewhere as specified by the ORAN and 3GPP interfaces for 4G/5G.

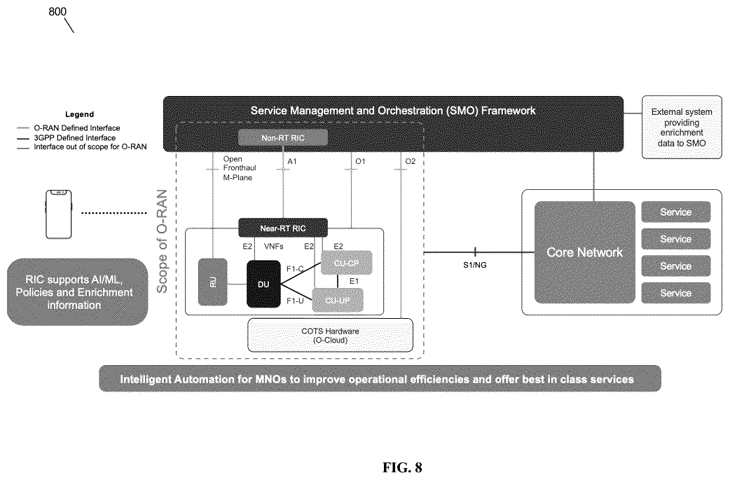

FIG. 8 is a fifth schematic diagram of a multi-RAT RAN deployment architecture, in accordance with some embodiments. This schematic diagram shows the use of the near/non-RT RIC to provide AI/ML (artificial intelligence and machine learning) policies and enrichment across Gs. This may also involve an SMO framework that is outside of the RAN, that is interfaced through the non-RT RIC, and may also involve an external system providing enrichment data to the SMO, as well as the core network and any services thereon, in some embodiments. The all-G Non-RT RIC serves as the integration point for performing network optimizations and adjustments that take into account any offline processes for Al/ML that involve adjustments that operate outside of the UE latency window (for 4G/5G ^{˜}100 ms), in some embodiments.

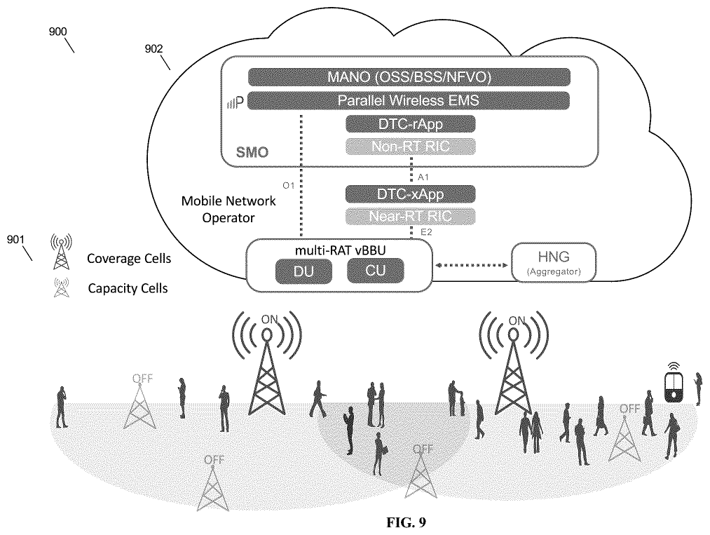

FIG. 9 is a schematic diagram of a multi-RAT RAN deployment in operation, in accordance with some embodiments. Diagram 901 is a schematic diagram of users in proximity to a variety of cells, labeled coverage cells and capacity cells. Coverage cells provide users with a connection to the network that is durable, typically located at a high tower; this type of connection may not, however, enable high bandwidth given the large number of users supported at such cells. Capacity cells support a smaller number of users and use different radio technologies to enable high throughput to users. Capacity and coverage cells are enabled to trade off users as needed to maintain the needs of the network and the users as well. The diagram shows that while there are several capacity cells available in the network, they are all turned off.

Diagram 902 is a schematic diagram of the operator network, in accordance with some embodiments. A multi-RAT vBBU is in communication with a near-RT RIC and a non-RT RIC, as well as a Parallel Wireless element management system (EMS), which provides the system with awareness about active network nodes, as well as a MANO (OSS/BSS/NFVO) for network operational capabilities. The coverage and capacity cells shown in 901 are in communication with the all-G near-RT RIC and all-G non-RT RIC. Network functions are managed by applications, called xApps when running on the near-RT RIC and rApps when running on the non-RT RIC, and these applications are in communication with each other and aware of the network conditions through information available at the systems on which they are running.

In operation, for some embodiments, for example, when a coverage cell is heavily loaded, an rApp on the non-RT RIC and an xApp on the near-RT RIC coordinate to identify a mitigation, which can include identifying an appropriate capacity cell to activate; activating the cell; and handing over users from the coverage cell to the newly active cell. In another example, in some embodiments, in the case that admission control is identified as causing too many users to be admitted to the network at the same time, throttling may be performed. Monitoring of network load and a subsequent instruction to perform throttling may be initiated at the near-RT RIC using an xApp, in some embodiments. This may be a multi-RAT activity and this may involve monitoring of network load for a first RAT and an instruction to perform throttling for a second RAT, in some embodiments.

Although the above systems and methods for providing interference mitigation are described in reference to the Long Term Evolution (LTE) standard, one of skill in the art would understand that these systems and methods could be adapted for use with other wireless standards or versions thereof. For example, 802.11n or 5G NR could be supported, as well as any other OFDM radio standard.

The word “cell” is used herein to denote either the coverage area of any base station, or the base station itself, as appropriate and as would be understood by one having skill in the art. For purposes of the present disclosure, while actual PCls and ECGIs have values that reflect the public land mobile networks (PLMNs) that the base stations are part of, the values are illustrative and do not reflect any PLMNs nor the actual structure of PCI and ECGI values.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, legacy TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for providing uplink scheduling in a cellular radio base station, comprising:
an uplink (UL) scheduler running 6 TTI in advance to thereby provide a list of all Radio Network Temporary Identifiers (RNTIs) to be scheduled on a given UL slot;
allocating, at a PDCCH resource allocator, control channel elements (CCEs) for all downlink (DL) RNTIs first;
allocating, at the PDCCH resource allocator, CCEs for at least one UL RNTI for a first DL slot;
placing RNTIs not allocated in the first DL slot in a pending queue.

2. The method of claim 1, wherein for the first allocation, PDCCH tries to allocate CCEs using K2=6.

3. The method of claim 1, wherein RNTIs not allocated in this DL slot are placed in a pending queue

4. The method of claim 1, wherein if UL RBs are left, distributing, by the UL resource allocator, the remaining UL RBs to other scheduled RNTIs in the given slot.

5. The method of claim 1, wherein in the next DL slot, the PDCCH allocator tries to allocate CCEs for UEs in the pending queue with K2=4.

6. The method of claim 1, wherein in a subsequent DL slot, the PDCCH allocator tries to allocate CCEs for UEs in the pending queue with K2=3.

7. The method of claim 1, wherein in a subsequent DL slot, the PDCCH allocator tries to allocate CCEs for UEs in the pending queue with K2=2.

8. A non-transitory computer-readable medium containing instructions which, when executed on a processor at a cellular base station, performs steps, the steps comprising:
an uplink (UL) scheduler running 6 TTI in advance to thereby provide a list of all Radio Network Temporary Identifiers (RNTIs) to be scheduled on a given UL slot;
allocating, at a PDCCH resource allocator, control channel elements (CCEs) for all downlink (DL) RNTIs first;
allocating, at the PDCCH resource allocator, CCEs for at least one UL RNTI for a first DL slot;
placing RNTIs not allocated in the first DL slot in a pending queue.

9. The non-transitory computer-readable medium of claim 8, the instructions further comprising, for the first allocation, PDCCH tries to allocate CCEs using K2=6.

10. The non-transitory computer-readable medium of claim 8, the instructions further comprising, RNTIs not allocated in this DL slot are placed in a pending queue

11. The non-transitory computer-readable medium of claim 8, the instructions further comprising, if UL RBs are left, distributing, by the UL resource allocator, the remaining UL RBs to other scheduled RNTIs in the given slot.

12. The non-transitory computer-readable medium of claim 8, the instructions further comprising, in the next DL slot, the PDCCH allocator tries to allocate CCEs for UEs in the pending queue with K2=4.

13. The non-transitory computer-readable medium of claim 8, the instructions further comprising, in a subsequent DL slot, the PDCCH allocator tries to allocate CCEs for UEs in the pending queue with K2=3.

14. The non-transitory computer-readable medium of claim 8, the instructions further comprising, in a subsequent DL slot, the PDCCH allocator tries to allocate CCEs for UEs in the pending queue with K2=2.
